(19) United States
(12) Patent Application Publication
(10) Pub. No.: US 2016/0096736 A1
(43) Pub. Date: Apr. 7, 2016

(54) TRANSPARENT CONDUCTIVE ARTICLE

(71) Applicant: GrafTech International Holdings Inc., Brooklyn Heights, OH (US)

(72) Inventor: Saad Hasan, Cleveland, OH (US)

(73) Assignee: GRAFTECH INTERNATIONAL HOLDINGS INC., Brooklyn Heights, OH (US)

(21) Appl. No.: 14/875,353

(22) Filed: Oct. 5, 2015

Related U.S. Application Data
(60) Provisional application No. 62/059,311, filed on Oct. 3, 2014.

(51) Int. Cl. C01B 31/04; H01B 1/04

(52) U.S. Cl. CPC C01B 31/0484; H01B 1/04

(57) ABSTRACT

A transparent conductive article which includes one of more graphene sheets, at least one of the sheets having a sheet resistance of less than 100 Ω/□. The transparent conductive article includes no more than ten graphene sheets. The transparent conductive article can have a transmission of at least 90%. The one or more sheets can have a transmission of at least 90%. A method of making a transparent conductive sheet includes heat treating a chemical vapor deposition (CVD) grown graphene sheet, the sheet having a width dimension of at least 1 cm, in a non-oxidizing environment to a temperature of at least 2400° C. for a sufficient period of time to have a sheet resistance of less than 100 Ω/□ and a transmittance of at least 90%. Prior to heat treating, the sheet is disposed on a suspension media, such as flexible graphite, having a chemical and thermal stability such that the suspension media functionally survives the heat treating step.

### CROSS REFERENCE TO RELATED APPLICATIONS

This application claims the benefit of U.S. Provisional Application No. 62/059,311, filed Oct. 3, 2014.

### TECHNICAL FIELD

The field of the disclosure relates to a transparent conductive sheet formed from graphene and methods of making such sheets. Graphene is a substance that has been known for more than fifty (50) years, dating at least back to 1962 with Hanns-Peter Boehm's discovery of isolated single graphene sheets through transmission electron microscopy (TEM) and X-ray diffraction (XRD). To this date, there are still very few commercial applications for graphene.

### BRIEF DESCRIPTION

An aspect of the disclosure is a method of making a transparent conductive sheet. The method may include heat treating a CVD grown graphene sheet, having a width dimension which comprises at least 1 cm, in a non-oxidizing environment. The heat treating may take place at a temperature of at least 2400° C. for a sufficient period of time, so that the sheet has a sheet resistance of less than 100 Ω/□ and a transmittance of at least 90%. Units of sheet resistance, a special case of resistivity for a uniform sheet thickness, as used herein (Ω/□) are also referred to as “ohms per square” or Ω/sq.

Another aspect of the disclosure includes a transparent conductive article. The article may have no more than ten (10) sheets of CVD grown graphene, having a sheet resistance of less than 100 Ω/□. Preferably, the article has a transmission of at least 90%.

It is to be understood that both the foregoing general description and the following detailed description provide embodiments of the disclosure and are intended to provide an overview or framework of understanding the nature and character of the invention as it is claimed.

### BRIEF DESCRIPTION OF THE DRAWINGS

FIG. 1a is a side view of a transparent conductive article formed of one CVD grown graphene sheet after heat treating as described herein;

FIG. 1b is a side view of a transparent conductive article formed of a plurality of CVD grown graphene sheets after heat treating as described herein;

FIG. 1c is a side sectional view of a CVD grown graphene sheet disposed on a suspension media prior to heat treating as described herein; and

FIG. 1d is a side sectional view of a CVD grown graphene sheet disposed on another configuration of a suspension media prior to heat treating as described herein.

### DETAILED DESCRIPTION

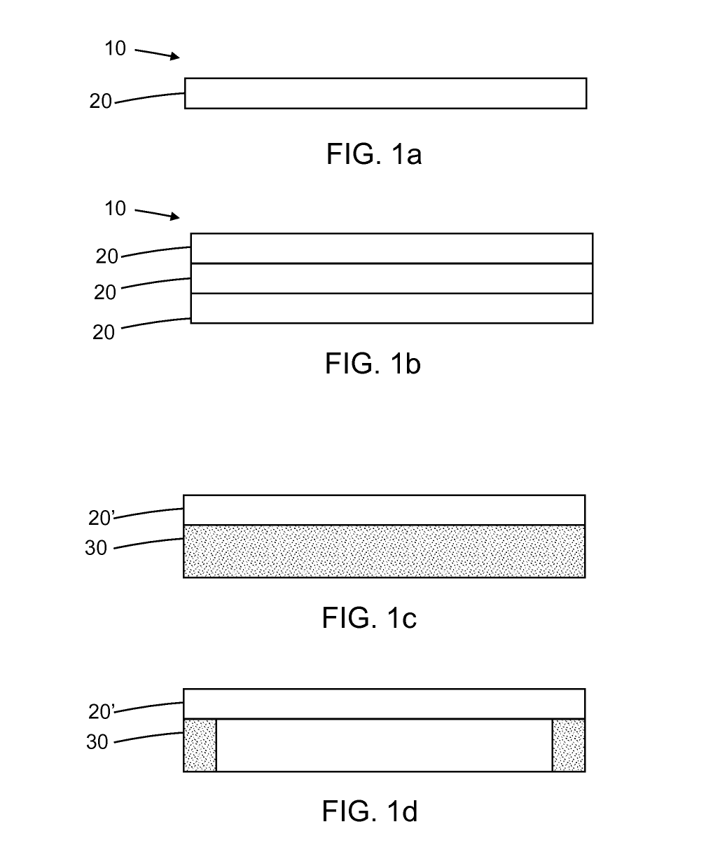

One embodiment included herein includes a method of making a transparent conductive article. The article, shown generally at 10 in FIG. 1a, may be in the form of one (1) sheet or an assembly of more than one (1) sheet but not more than ten (10) sheets 20 as shown in FIG. 1b. The method includes heat treating at least one chemical vapor deposition (CVD) grown graphene sheet 20′ shown in FIG. 1c. A source of CVD grown graphene 20′ is ACS Material LLC of Medford, Mass. Preferably, a width dimension of the sheet 20′ comprises at least 1 cm. The heating may take place in a non-oxidizing environment. A non-exclusive list of examples of such a non-oxidizing environment include argon, nitrogen, helium, neon or combinations thereof.

The temperature of such heat treating comprises at least 2400° C. for a sufficient period of time, such that a sheet resistance of the heat treated article 10 comprises less than 100 Ω/□ and a transmittance of at least 90%. In one non-liming example, the period of time is a least one hour. The temperature of such heat treatment may range from anywhere from about 2400° C. up to about 3400° C. One particular example of a suitable heat treating temperature comprises up to 2600° C. Additionally, the embodiment is not limited to any particular heat treating temperature profile. Though not to beyond to any particular theory it is believed that the heat treating will result in reducing the number of crystals that make-up the sheet, but the average size of the crystals will have increased. One technique to determine the crystal size is by X-ray diffraction (“XRD”).

Preferred sheet resistance include less than 100 Ω/□, less than 50 Ω/□, less than 25 Ω/□ or no more than 10 Ω/□. One technique to test sheet resistance includes the Van der Pauw method, using a 4-probe device.

The above embodiment may include one or more of the below described optional process steps or any combination thereof:
a. the heat treating may include heat treating a plurality of sheets 20′ at the same time;
b. prior to such heat treating, the sheet 20′ may be disposed onto a suspension media 30, wherein the suspension media has a chemical and thermal stability such that the suspension media functionally survives the heat treating step; and/or
c. transferring the sheet 20′ from a first carrier to the suspension media 30.

An example of the above the suspension media 30 comprises flexible graphite. The flexible graphite 30 is preferably in the form of a sheet, which may have been previously rolled onto a mandrel. The flexible graphite 30 may include compressed particles of exfoliated graphite, graphitized polymer or combinations thereof. In one non-limiting example, the sheet 20′ is transferred from a Cu roll carrier it is grown on to a roll of flexible graphite 30. In another embodiment, the coefficient of thermal expansion (CTE) of the suspension media 30 is substantially similar to a CTE of the sheet 20′. A substantially similar CTE can mean that the CTEs are within twenty-five (25%) percent of each other in each direction. Another example of a substantially similar CTE is that the CTE of the suspension media and the sheet are not so different that during process growth or contraction of the suspension media 30 during process does not cause undesirable damage to the sheet 20′ or vice versa.

In addition, the suspension media 30 is not limited to any particular configuration. In one embodiment, the suspension 30 comprises a continuous web and the sheet is disposed on top of the continuous web. In another embodiment, the media 30 supports of the sheet only on a perimeter of the sheet 20′, further only on two opposed lateral edges of the sheet.

Another embodiment disclosed herein includes a transparent conductive article 10. The article includes no more than 10 sheets of CVD grown graphene 20, each sheet having a sheet resistance of less than 100 Ω/□. The article 10 has a transmission of at least 90%, preferably a transmission of at least 95%. The percent transmission of the article 10 may be measured with a spectroscope or an ellipsometry. An example of a spectroscope is the lambda 950 spectrophotometer from Perkin & Elmer. In a further embodiment, one or more of the CVD sheets 20 which make up the article 10 have a sheet resistance of less than 50 Ω/□. In even more preferred embodiment, one or more of the sheets 20 have a sheet resistance of less than 25 Ω/□, and most preferably a sheet resistance of less than 10 Ω/□.

In another embodiment of the article 10, preferably the article has a sheet resistance of less than 100 Ω/□. In a more preferred embodiment, one or more of the sheets 20 have a sheet resistance of less than 50 Ω/□, an even more preferred less than 25 Ω/□, and a most preferred embodiment no more than 10 Ω/□. In a particular embodiment the article 10 will include no more than ten (10) of the afore described CVD sheets 20, preferably any number of sheets less than ten (10) but at least one (1) such sheet.

An application for the article 10 may be as a touchscreen for an electronic device.

The above particular embodiments are not mutually exclusive of each other. The various embodiments described herein can be practiced in any combination thereof. The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

Thus, although there have been described particular embodiments of the present invention of a new and useful method for making a transparent conductive sheet, it is not intended that such references be construed as limitations upon the scope of this invention except as set forth in the following claims.

What is claimed is:

1. A method of making a transparent conductive sheet comprising:
a. heat treating a chemical vapor deposition (CVD) grown graphene sheet, the sheet having a width dimension comprising at least 1 cm, in a non-oxidizing environment to a temperature of at least 2400° C. for a sufficient period of time, whereby a sheet resistance of the heat treated sheet comprises less than 100 Ω/□ and a transmittance of at least 90%.

2. The method of claim 1 wherein the heat treating comprises heat treating a plurality of the sheets at the same time.

3. The method of claim 1 further comprising disposing the sheet on a suspension media prior to the heat treating, wherein the suspension media having a chemical and thermal stability such that the suspension media functionally survives the heat treating step.

4. The method of claim 3 wherein the suspension media comprises flexible graphite.

5. The method of claim 3 wherein the suspension media supports of the sheet only on a perimeter of the sheet.

6. The method of claim 3 wherein a coefficient of thermal expansion (CTE) of the suspension media is substantially similar to a CTE of the sheet.

7. The method of claim 3 further comprising transferring the sheet from a first carrier to the suspension media.

8. The method claim 1 conducting said heat treating for a period of at least one hour.

9. The method of claim 1 wherein the temperature comprises at least 2600° C.

10. A transparent conductive article comprising:
a. at least one sheet and no more than ten sheets of chemical vapor deposition (CVD) grown graphene, each having a sheet resistance of less than 100 Ω/□;
b. the article having a transmission of at least 90%.

11. The article of claim 10 having a transmission of at least 95%.

12. The article of claim 10 wherein the article has a sheet resistance comprising less than 100 Ω/□.

13. The article of claim 12 wherein the article has a sheet resistance comprising less than 50 Ω/□.

14. The article of claim 13 wherein the article has a sheet resistance comprising less than 25 Ω/□.

15. The article of claim 10 wherein one or more of the sheets have a sheet resistance of less than 50 Ω/□.

16. The article of claim 15 wherein one or more of the sheets have a sheet resistance of less than 25 Ω/□.

17. The article of claim 16 wherein one or more of the sheets have a sheet resistance of less than 10 Ω/□.

18. The article of claim 10 wherein all the sheets have a sheet resistance of less than 50 Ω/□.

19. The article of claim 18 wherein all of the sheets have a sheet resistance of less than 10 Ω/□.

20. An electronic device touchscreen comprising at least one sheet and no more than ten sheets of chemical vapor deposition (CVD) grown graphene, each sheet having a sheet resistance of less than 100 Ω/□, wherein the touchscreen has a transmission of at least 90%.
